(19) United States
(12) Patent Application Publication
(10) Pub. No.: US 2010/0180137 A1
(43) Pub. Date: Jul. 15, 2010

(54) CONTROL DEVICE

(76) Inventors: Tsuyoshi Sato, Osaka (JP); Makoto Fujiwara, Kyoto (JP); Kenichiro Uda, Osaka (JP)

Correspondence Address: MCDERMOTT WILL & EMERY LLP, 600 13TH STREET, NW, WASHINGTON, DC, 20005-3096, US

(21) Appl. No.: 12/377,200

(22) PCT Filed: Aug. 17, 2007
(86) PCT No.: PCT/JP2007/066032

§ 371 Date: Feb. 11, 2009

(30) Foreign Application Priority Data
Aug. 25, 2006 (JP) 2006-228951

(51) Int. Cl. G06F 1/32; H04L 9/10

(52) U.S. Cl. 713/324; 380/277

(57) ABSTRACT

A control device performs the reading of data from a recording medium that is authenticated mutually or the writing of data into the recording medium. The control device includes an interface section which interfaces with the recording medium, a storing section which stores key information and authentication information produced in an authentication operation, and a controlling section which controls a supply of power based on whether or not the control device performs either the reading of data from the recording medium or the writing of data into the recording medium. While the control device performs neither the reading of data from the recording medium nor the writing of data into the recording medium, the controlling section controls so as to supply only to the storing section. Therefore, in the control device, a reduction in the number of times of mutual authentication with a recording medium is compatible with low power consumption.

### TECHNICAL FIELD

The present invention relates to a control device for performing reading of data from a recording medium that is authenticated mutually or writing of data into the recording medium.

### BACKGROUND ART

JP-A-2004-320174 discloses the technology that performs authentication mutually with the recording medium by using an input/output interface to/from the recording medium. According to this technology, an electronic device that employs the recording medium equipped with a copyright protecting function as an external recording medium can perform authentication mutually with the concerned recording medium. Also, JP-A-2003-099332 discloses the technology that is capable of holding a plurality of authenticated states simultaneously. According to this technology, an electronic device can hold a plurality of different keys in answer to the authentication type.
Patent Literature 1: JP-A-2004-320174
Patent Literature 2: JP-A-2003-099332

### DISCLOSURE OF THE INVENTION

### Problems that the Invention is to Solve

The above technologies are utilized in an electronic device such as a cellular phone, or the like. The electronic device perform authentication mutually with the recording medium when such electronic device has access to an external recording medium. In particular, the battery-powered electronic device such as the cellular phone, or the like does not supply a power to a part of internal circuits containing SRAM, in which authentication information, etc. are stored, while such electronic device neither reads data from the recording medium nor write data to the recording medium, and thus achieves low power consumption. However, when the electronic device tries to have access to the recording medium again after a supply of the power is interrupted in the concerned electronic device and the authentication information is erased, the concerned electronic device has to perform the similar cross-authentication once again. As a result, in some cases the cross-authentication must be applied again even to the recording medium that has been authenticated once. In this manner, in the battery-powered electronic device, low power consumption can be achieved at the sacrifice of user's usability.

It is an object of the present invention to provide a control device in which a reduction in the number of times of mutual authentication with a recording medium is compatible with low power consumption.

### Means for Solving the Problems

The present invention provides a control device for performing reading of data from a recording medium that is authenticated mutually or writing of data into the recording medium, which includes an interface section which interfaces with the recording medium; a storing section which stores key information and authentication information produced in an authentication operation; and a controlling section which controls a supply of power based on whether or not the control device performs either the reading of data from the recording medium or the writing of data into the recording medium; wherein the controlling section controls so as to supply the power only to the storing section, while the control device performs neither the reading of data from the recording medium nor the writing of data into the recording medium.

In the above control device, the storing section stores a plurality of sets of key data and authentication information.

In the above control device, the authentication information includes key data storing location information indicating a storing location of the key data and authentication type information indicating an attribute of the key data.

### Advantages of the Invention

According to the control device according to the present invention, a reduction in the number of times of mutual authentication with a recording medium is compatible with low power consumption.

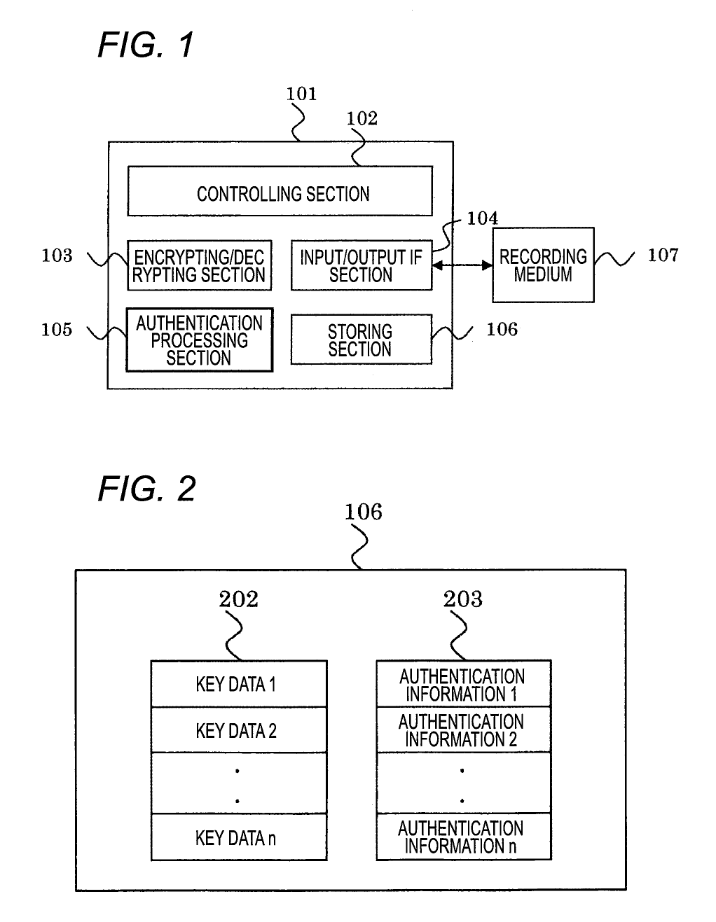

### BRIEF DESCRIPTION OF THE DRAWINGS

[FIG. 1] A block diagram showing a control device according to an embodiment of the present invention.

[FIG. 2] A block diagram showing information stored in a storing section.

### DESCRIPTION OF REFERENCE NUMERALS

101 control device
102 controlling section
103 encrypting/decrypting section
104 input/output IF section
105 authentication processing section
106 storing section
107 recording medium

### BEST MODE FOR CARRYING OUT THE INVENTION

An embodiment of the present invention will be explained with reference to the drawings hereinafter. A control device of the embodiment explained hereunder reads the data, which is encrypted based on the standard for copyright protection such as CPRM (Content Protection for Recordable Media), or the like, from a recording medium or writes the data to the recording medium, while performing authentication mutually with a recording medium such as recordable DVD, memory card, or the like.

FIG. 1 is a block diagram showing a control device according to an embodiment of the present invention. As shown in FIG. 1, a control device 101 of the present embodiment includes an input/output IF section 104, an authentication processing section 105, an encrypting/decrypting section 103, a controlling section 102, and a storing section 106.

The input/output IF section 104 gives an interface between the control device and an external recording medium 107 such as recordable DVD, memory card, or the like. The authentication processing section 105 performs a cross-authentication with the recording medium 107, and produces key data peculiar to the recording medium 1 by using information that the input/output IF section 104 got from the recording medium 107. The encrypting/decrypting section 103 decrypts the data read from the recording medium 107 or encrypts plaintext data, by using the key data that the authentication processing section 105 produced.

The controlling section 102 controls the reading of data from the recording medium 107 or the writing of data into the recording medium 107. Also, the controlling section 102 controls a supply of power to the input/output IF section 104, the authentication processing section 105, and the encrypting/decrypting section 103. The controlling section 102 executes the control such that, while neither the reading of data from the recording medium 107 nor the writing of data into the recording medium 107 is performed, a power is supplied only to the storing section 106 but a power is not supplied to the input/output IF section 104, the authentication processing section 105, and the encrypting/decrypting section 103.

The key data produced by the authentication processing section 105 is different every recording medium which the control device 101 has access to. Also, the key data is different depending on the attribute of the data read from the recording medium 107 or the data written into the recording medium 107 (e.g., music data or video data). The controlling section 102 stores the attribute of data as well as the key data that the authentication processing section 105 produced, as the authentication type in the storing section 106. The storing section 106 stores the key data produced by the authentication processing section 105 and the attribute of data (authentication type) separately in different areas respectively. As shown in FIG. 2, the storing section 106 has a key data storing area 202 and an authentication information storing area 203. The key data is stored in the key data storing area 202. In contrast, key data storing location information indicating the storing location of each key data and authentication type information indicating the attribute of each key data are stored in the authentication information storing area 203. Also, a plurality of sets of key data, key data storing location information, and authentication type information can be stored in the storing section 106.

As explained above, according to the control device 101 of the present invention, two areas of the key data storing area 202 and the authentication information storing area 203 are provided in the storing section 106. Therefore, this control device can hold a plurality of types of authentication state at the same time. As a result, when the control device 101 reads the data whose attribute has already been authenticated from the recording medium 107 or writes the data whose attribute has already been authenticated into the recording medium 107, there is no need for the control device 101 to perform the authentication once again.

Also, while the control device 101 performs neither the reading of data from the recording medium 107 nor the writing of data into the recording medium 107, the controlling section 102 make such a control that a power is not supplied to the input/output IF section 104, the authentication processing section 105, and the encrypting/decrypting section 103 but supplied only to the storing section 106. In case the storing section 106 is SRAM, the information stored in the key data storing area 202 and the authentication information storing area 203 are erased totally at a moment when a supply of power is interrupted. However, in the control device 101 of the present embodiment, a power is always supplied to the storing section 106 and therefore the information stored in the storing section 106 are never erased.

With the above, the number of times of mutual authentication with the recording medium 107 can be reduced while suppressing a power consumption lower. In this event, the control device 101 may be composed of either an integrated circuit or discrete components.

The present invention is explained in detail with reference to particular embodiment. But it is obvious for those skilled in the art that various variations and modifications can be applied without departing from a spirit and a scope of the present invention.

This application is based upon Japanese Patent Application (Patent Application No. 2006-228951) filed on Aug. 25, 2006; the contents of which are incorporated herein by reference.

### INDUSTRIAL APPLICABILITY

The control device according to the present invention is useful as the electronic device that performs the reading of data from the recording medium that is authenticated mutually or the writing of data into the recording medium, or the like.

1. A control device for performing reading of data from a recording medium that is authenticated mutually or writing of data into the recording medium, comprising:
an interface section which interfaces with the recording medium;
a storing section which stores key information and authentication information produced in an authentication operation; and
a controlling section which controls a supply of power based on whether or not the control device performs either the reading of data from the recording medium or the writing of data into the recording medium;
wherein the controlling section controls so as to supply the power only to the storing section, while the control device performs neither the reading of data from the recording medium nor the writing of data into the recording medium.

2. The control device according to claim 1, wherein the storing section stores a plurality of sets of key data and authentication information.

3. The control device according to claim 1, wherein the authentication information includes key data storing location information indicating a storing location of the key data and authentication type information indicating an attribute of the key data.

4. The control device according to claim 2, wherein the authentication information includes key data storing location information indicating a storing location of the key data and authentication type information indicating an attribute of the key data.
